(19) United States
(12) Patent Application Publication
(10) Pub. No.: US 2025/0146304 A1
(43) Pub. Date: May 8, 2025

(54) HIDDEN FASTENER FREE DECK CLIP

(71) Applicant: Grabber Construction Products, Inc., Highland, UT (US)

(72) Inventors: Andrew E. Reed, Trumbull, CT (US); Christopher D. Hageman, Glastonbury, CT (US); David Mathieu, Ocala, FL (US); John Jason Roxburgh, Lake Wylie, SC (US)

(21) Appl. No.: 18/936,600

(22) Filed: Nov. 4, 2024

Related U.S. Application Data
(60) Provisional application No. 63/595,558, filed on Nov. 2, 2023.

(51) Int. Cl. E04F 15/02; B25B 31/00

(52) U.S. Cl. CPC E04F 15/02044; B25B 31/00; E04F 2015/02122

(57) ABSTRACT

Fastener-free deck clips, methods of use, and associated installation tools. The clips use a gripping element to secure the clip to a joist and do not require the use of a separate screw or other fastener, simplifying the installation process. The clip has a central body with lateral wings extending to an endpoint, where the gripping element is located. The gripping element may include puncturing elements to adhere better to the joist. Likewise, the main body may have tabs that can be depressed to further adhere to the joist. The clips may be installed by use of a handheld tool.

### CROSS-REFERENCE TO RELATED APPLICATIONS

This application claims the benefits of US. Prov. Pt. pp, Ser. No. 63/595,558, filed Nov. 2, 2023, the entire disclosure of which is incorporated herein by reference.

### BACKGROUND OF THE INVENTION

### Field of the Invention

This disclosure is related to the field of construction, and more particularly to systems and methods for securing boards to joists or other framing elements.

### Description of the Related Art

Residential decks serve as versatile outdoor living spaces that provide numerous functions, uses, and benefits to homeowners. They serve as extensions of the indoor living area, allowing people to enjoy the outdoors comfortably. Decks are commonly used for various activities such as hosting gatherings, barbecues, relaxing and spending quality time with family and friends. They offer a designated space for outdoor furniture, plants and décor, allowing homeowners to create a personalized and inviting outdoor oasis. Residential decks also provide an excellent vantage point to appreciate the surrounding landscape and enjoy fresh air. Additionally, decks can increase the overall value of a property, enhance its curb appeal and provide a desirable feature for potential buyers. Their popularity stems from the fact that they offer a convenient and enjoyable way to expand living space, connect with nature and create a seamless transition between indoor and outdoor areas.

The installation process of a residential deck typically involves clearing the area where the deck will be installed of vegetation or debris, leveling the ground and setting footings or piers to establish a foundation. The footings support the deck's weight and lend structural stability by transmitting loads to the Earth. Once the footings are placed, vertical posts are installed and beams are attached to the posts to create the framework of the deck. Joists are then attached to the beams to form a base for the deck surface, which are then attached to the base by installing the decking—usually planks of treated lumber or composite materials-on the joists. Finally, railings, stairs and decorative features may be added.

This process, though simple in concept, can be challenging, time-consuming and expensive. Precise measurements are required, along with accurate leveling, structural calculations and proper use of construction techniques to ensure safety and stability. The installation of the deck surface, whether lumber or composite materials, often involves cutting, fitting, and fastening numerous boards, a demanding and time-consuming process. Installing the actual decking can be challenging due to several factors. Ensuring proper alignment and spacing of the deck planks requires precise measurement and attention to detail to ensure consistency and an aesthetically pleasing appearance.

Also, fastening the deck boards securely is important to stability and longevity, and may require specialized tools or equipment. Ensuring that the fasteners are correctly driven into the appropriate locations without damaging the boards or fasteners is a precise operation, especially when dealing with different board lengths and angles, and if the installer is not careful the fasteners may be misaligned with the underlying joists and miss them entirely. Of particular relevance, the process of installing fasteners currently existing in the market is quite time consuming. The process requires the user to insert the fastener in the groove of the deck board, slide the fastener to a position centered over the joist—taking particular care to ensure the fastener is in the appropriate position—then using a drill to drive a screw into the joist until the screw is flush with the fastener. If the user installs the screw too high, the fastener will be loose, if it is installed too low, the fastener will not hold the deck board properly. Thus, the installation of fasteners is generally a time consuming part of the deck installation process. Further, because this work is often done while working high above the ground, where workers' attention is focused elsewhere, the risk of a worker experiencing a fall is increased while worker safety is decreased.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, are systems and methods for faster deck construction using fastener free deck clips. At a high level of generality, the fastener free deck clips use a gripping element to secure the clip onto the joist and do not require the use of a separate screw or other fastener. This removes a step and a component from the installation process, thus reducing the time spent installing the deck and the amount of hardware to stock and transport. Further, the fastener free deck clip may be installed by use of a handheld tool, which may hold one or more fastener free deck clips and the tool may use an energy source, such as a pneumatic supply, to expedite the installation process. The clips may be fastened to the joists via this handheld tool before the decking is installed, and the decking can then be installed by sliding the decking groove onto the fastener free deck clips. These and other aspects of the fastener free deck clip are described in further detail herein.

Also described herein, among other things, is a deck clip comprising: a main body element comprising: a central portion generally in the configuration of a rectangular prism having a major plane; and a first longitudinal portion adjacent a first side of the central portion and comprising an extension of the central portion above the major plane; and a second longitudinal portion adjacent a second side of the central portion and comprising an extension of the central portion above the major plane; a pair of arms disposed on opposing sides of the main body element and extending generally colinearly therefrom in opposing directions, a major axis of each of the arms generally perpendicular to the major plane; and a gripping element disposed at a distal end of each of the arms, the gripping elements each comprising one or more puncturing spikes.

In an embodiment, the deck clip further comprises a first flexible tab cut out of the main body element such that the first tab is not connected to the main body element on three sides, the first tab bending downwards from the major plane in a direction opposite the first longitudinal portion and the second longitudinal portion.

In an embodiment, the deck clip further comprises a second flexible tab cut out of the main body element such that the second tab is not connected to the main body element on three sides, the second tab bending downwards from the major plane in a direction opposite the first longitudinal portion and the second longitudinal portion.

In another embodiment, each of the arms is about the same size as the other and has a width that increases at the distal end prior to the gripping element.

In a further embodiment, at least one of the arms is mechanically separable from the main body element.

In a further embodiment, both of the arms are mechanically separable from the main body element.

In a further embodiment, wherein the puncturing spikes are generally in a triangular configuration and extending generally perpendicularly from the gripping elements.

In a further embodiment, the deck clip is manufactured from a flat piece of sheet metal and bent into shape.

In a further embodiment, the first body element further comprises a bore extending through the main body element from a top side to a bottom side.

In a further embodiment, the bore is disposed in about a center of the main body element.

Also described herein, among other things, is a collated set of any of the foregoing deck clips comprising a plurality of such deck clips arranged linearly.

Also described herein, among other things, is a method of installing a deck clip, comprising: providing a deck clip comprising: a main body element comprising: a central portion generally in the configuration of a rectangular prism having a major plane; and a first longitudinal portion adjacent a first side of the central portion and comprising an extension of the central portion above the major plane; and a second longitudinal portion adjacent a second side of the central portion and comprising an extension of the central portion above the major plane; a pair of arms disposed on opposing sides of the main body element and extending generally colinearly therefrom in opposing directions, a major axis of each of the arms generally perpendicular to the major plane; and a gripping element disposed at a distal end of each of the arms, the gripping elements each comprising one or more puncturing spikes; disposing the deck clip atop a decking joist such that the main body element is parallel to a top side of the decking joist and each of the arms is disposed parallel to a lateral side of the decking joist; and driving the gripping elements of each of the arms toward a midpoint of the decking joist until the puncturing spikes are embedded in the decking joist.

In an embodiment, the method further comprises: the deck clip further comprising: a first flexible tab cut out of the main body element such that the first tab is not connected to the main body element on three sides, the first tab bending downwards from the major plane in a direction opposite the first longitudinal portion and the second longitudinal portion; and a second flexible tab cut out of the main body element such that the second tab is not connected to the main body element on three sides, the second tab bending downwards from the major plane in a direction opposite the first longitudinal portion and the second longitudinal portion; driving the first flexible tab and the second flexible tab into the top of the decking joist.

In another embodiment, the method further comprises: providing a tool for installing the deck clips, the tool comprising a handle attached to a main body having a hammer contact operatively connected to a strike plate; the disposing the deck clip atop the decking joist further comprising disposing the tool on the decking joist such that the such that the strike plate is disposed above the top of the decking joist, and disposing the deck clip in a the tool; striking the hammer contact; and the striking operating the strike plate to compress the main body element against the top of the decking joist.

In a further embodiment, the method further comprises: the tool further comprising the main body being generally in the configuration of an inverted U-shape comprising a pair of legs extending downward from opposing sides of a top section, each of the legs having a wing strike plate disposed on an inner surface thereof, the wing strike operatively coupled to the hammer contact; the disposing the deck clip atop the decking joist further comprising disposing the tool on the decking joist such that the such that the legs of the tool straddle the decking joist and each of the arms are disposed between the decking joist and one of the legs of the tool; and the striking further operating each of the wing strike plates to compress one of the arms of the deck clip against a lateral surface of the decking joist.

### BRIEF DESCRIPTION OF THE DRAWINGS

FIG. 1 is an isometric elevation view of a fastener free deck clip according to the present disclosure.

FIG. 2 is a top elevation view of an alternative embodiment of a flat or partially bent fastener free deck clip.

FIG. 3 is an isometric elevation view of an alternative embodiment a fastener free deck clip according to the present disclosure.

FIG. 4 is an isometric elevation view of an alternative embodiment of a fastener free deck clip wherein a gripping element is comprised of twisted puncturing spikes.

FIG. 5 is an isometric elevation view of an alternative embodiment of a fastener free deck clip wherein a gripping element is comprised of long, straight puncturing spikes.

FIG. 6 is an isometric elevation view of an alternative embodiment of a fastener free deck clip with arms angled inwards.

FIG. 7 is an isometric elevation view of an alternative embodiment of a fastener free deck clip wherein a gripping element is comprised of a single puncturing spike angled upwards, towards the deck clip base.

FIG. 8 is an isometric elevation view of an alternative embodiment of a fastener free deck clip where the puncturing spikes are comprised of barbed teeth.

FIGS. 9A, 9B, and 9C provide isometric views of an alternative embodiment of a multiple piece fastener free deck clip, according to the present disclosure.

FIGS. 10A, 10B, and 10C provide isometric views of an alternative embodiment of a multiple piece fastener free deck clip, according to the present disclosure.

FIG. 11 is an isometric elevation view of a partially installed deck using fastener free deck clips.

FIG. 12 is an isometric elevation view of an installed fastener free deck clip.

FIG. 13 is an isometric elevation view of an embodiment of a fastener free deck clip, as depicted in FIG. 1, installed.

FIG. 14 is a side elevation view of an alternative embodiment of a fastener free deck clip, as depicted in FIG. 1, installed.

FIG. 15 is an isometric elevation view of a collated set of fastener free deck clips according to the present disclosure.

FIG. 16 is an isometric elevation view of a handheld fastener free deck clip installation tool according to the present disclosure.

FIG. 17 depicts the handheld tool of FIG. 16 placed on a joist.

FIG. 18 is an isometric elevation view of an alternative embodiment of a handheld fastener free deck clip installation tool that uses an energy source to actuate the strike plate, according to the present disclosure.

FIG. 19 depicts a fastener free deck clip being loaded into a handheld device.

FIG. 20 depicts the handheld device being placed on a joist.

FIG. 21 depicts the handheld device being slid to the edge of a deck board.

FIG. 22 depicts the fastener free deck clip being inserted into the grooved edge of a deck board and a hammer striking the strike plate of the handheld tool.

FIG. 23 depicts a post fastener free deck clip installation position and the handheld tool being removed.

FIGS. 24A and 24B depict a fastener free deck clip placed in a handheld tool.

FIG. 25 depicts a collated clip of fastener free deck clips placed in a handheld tool.

FIG. 26 depicts an alternative embodiment of a hand-held installation tool.

FIGS. 27A, 27B, 27C, and 27D depict elevation and isometric views of the alternative embodiment of a hand-held installation tool.

FIGS. 28A and 28B depict the alternative embodiment of a hand-held installation tool in the installing of a fastener free deck clip.

FIGS. 29A and 29B depict the alternative embodiment of a hand-held installation tool in an uncompressed and compressed position.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

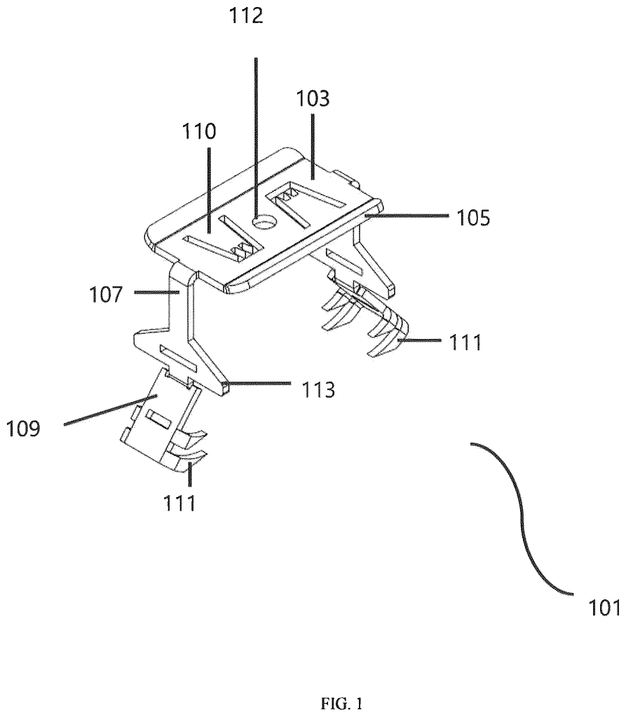

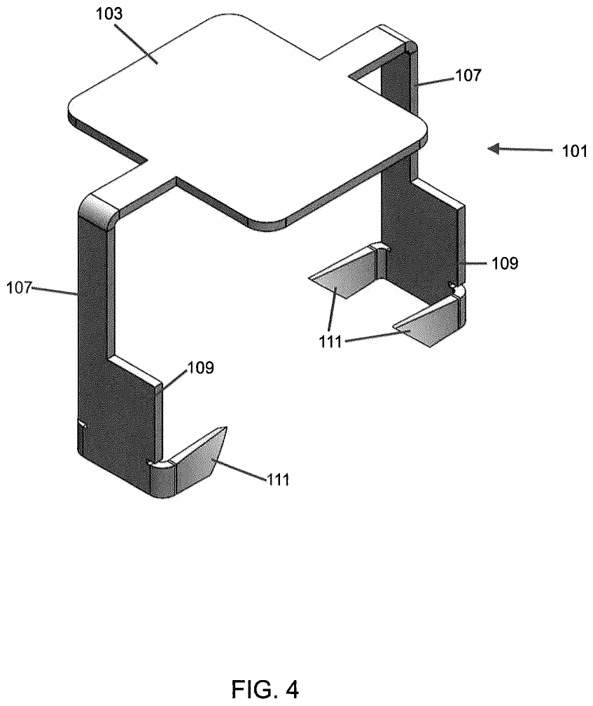

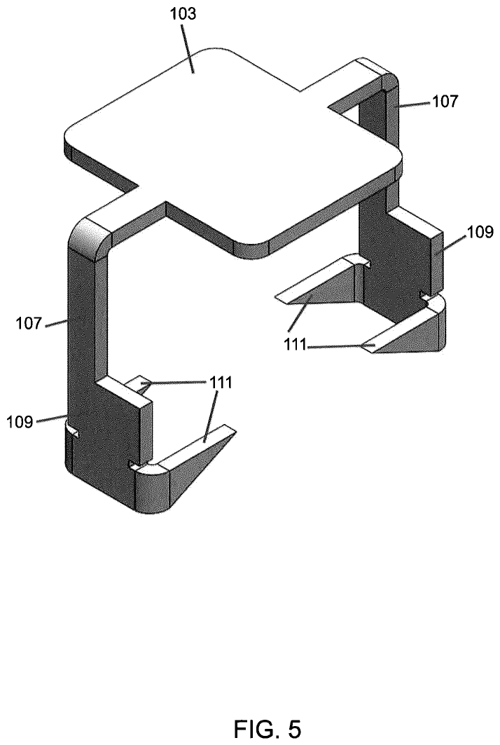

FIG. 1 depicts an embodiment of the fastener free deck clip (101) according to the present disclosure. The depicted fastener free deck clip (101) comprises a main body element (103) having at least one attached arm element (107), wherein the end of said arm contains gripping elements (109) disposed at a distal end thereof. In the depicted embodiment, the main body element (103) is generally in the configuration of a flat rectangular prism, but alternative shapes and embodiments are possible. For example, in the depicted embodiments of FIGS. 1, 2, and 3, the longitudinal portion (105) of the main body element is warped such that the long edges of the main body element (103) tilt upwards from the main plane. In other embodiments, the main body element (103) is generally in the configuration of a flat, square prism, such as depicted in FIGS. 4 and 5.

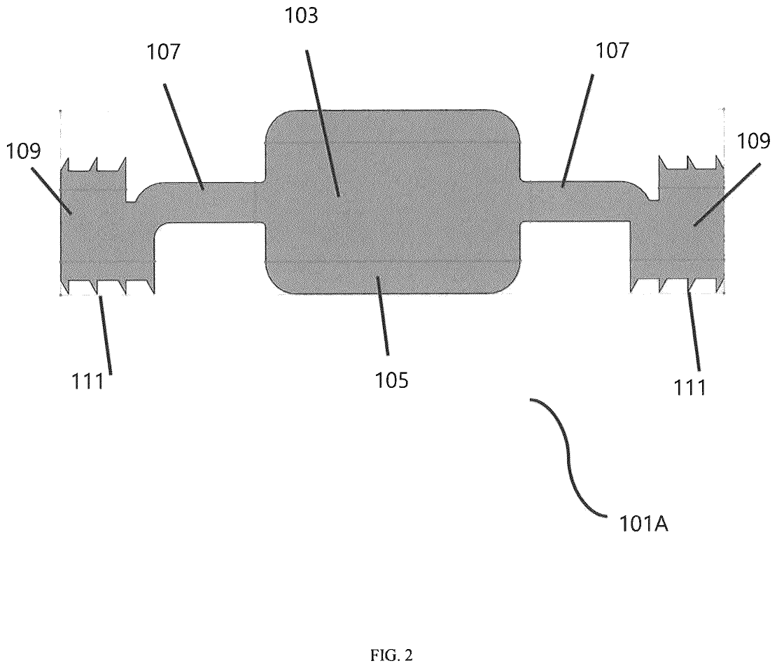

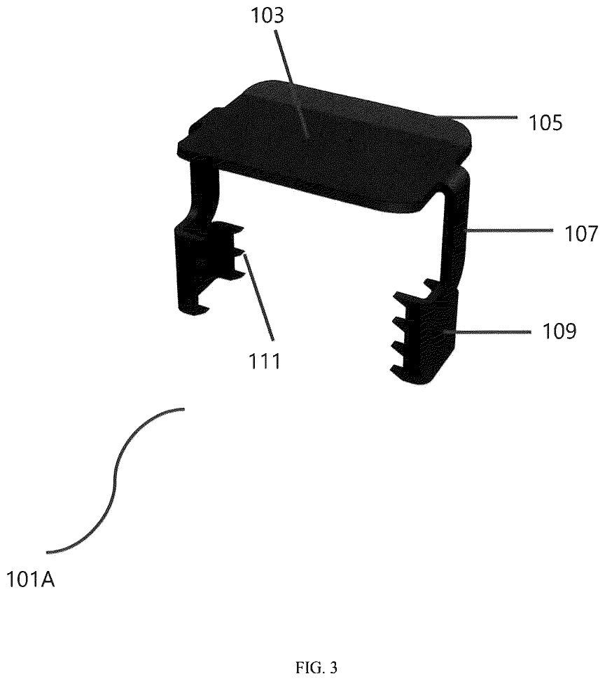

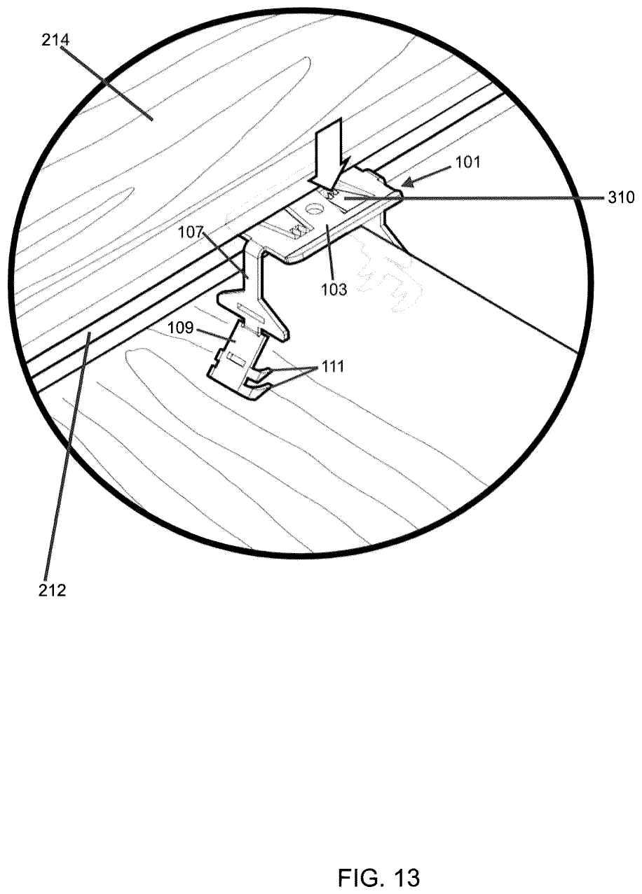

In the current embodiment, the main body element (103) comprises at least one flexible or bendable tab (110) that is cut out of the main body element (103), such that the tab is not connected to the main body element (103) on three sides and is connected on a side parallel to the major axis, as depicted in FIG. 1. The depicted bendable tab (110) may be bent downwards from the major plane of the main body (103) to make contact with the grooved edge (212) of a deck board (214), as depicted in FIG. 13, which may further prevent movement of said deck board (214) after installation and may result in increased stability of the constructed deck. Though not required for installation or use of the fastener free deck clip (101) herein described, this embodiment also comprises an option to secure the deck clip (101) to the joist via a separate screw or fastener inserted in a hole (112) in the center of the main body element (103), as depicted in FIG. 1. This is illustrative only, however, and other alternative configurations of the main body element (103) are possible. For example, in other embodiments, such as depicted in FIG. 2 and FIG. 3, the main body element (103) does not contain the bendable tabs (110) or fastener hole (112) as depicted in the current embodiment.

In the depicted embodiment of FIG. 1, the fastener free deck clip (101) comprises a pair of arms (107) disposed on opposing sides of the main body element (103) and extending generally colinearly therefrom in opposing directions, such that the major axis of the arms (107) is generally perpendicular to the side of the main body element (103) from which it extends. The distal end of the depicted arms (107) contains a gripping element (109) with one or more puncturing spikes (111).

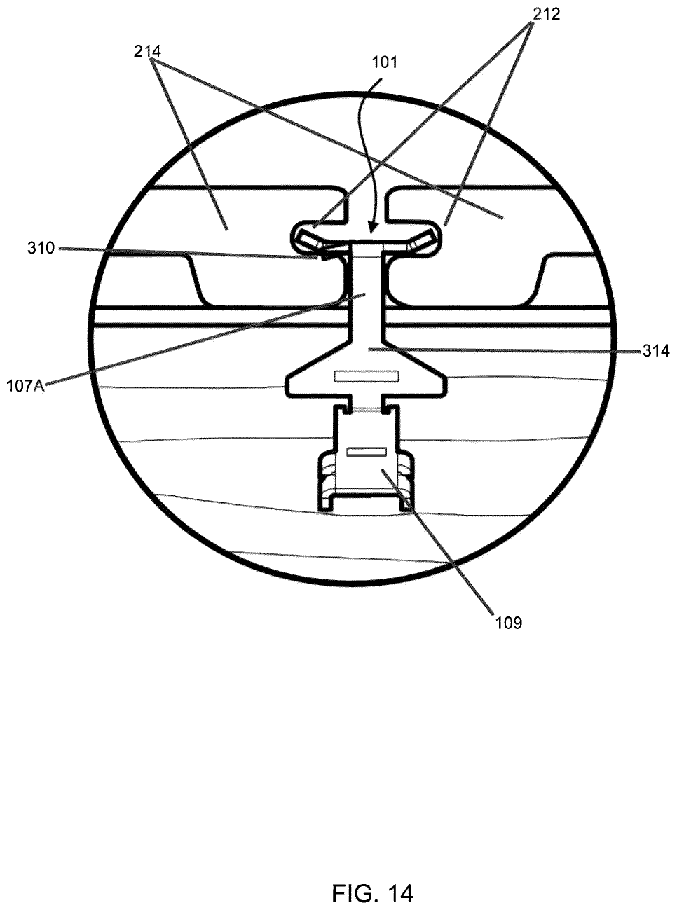

The arms (107) of the depicted embodiment are about the same size as each other and have a width that increases at the distal end (113) prior to the gripping element (109), such that the width of the arms (107) at the edge of the main body element (103) to which they are attached is substantially less than the width just prior to the gripping element (109), as depicted in FIG. 1. This increased width of the distal end of the arms (107) increases the contact surface area the arms have with the joist, which may ease installation by preventing oscillation of the arms as the clip is installed. The width of the arms (107) at the edge of the main body (103) is such that when the grooved edges (212) of the deck boards (214) are inserted on an already installed deck clip (101), installation of the deck clip is described elsewhere herein, the deck board (214) butts up against the width of the clip arms, which may provide consistent spacing for the deck boards (214), as depicted in FIG. 14.

However, this is illustrative only and alternative arrangements of the arms (107) and gripping elements (109) are possible. For example, in alternative embodiments of FIG. 2 and FIG. 3, the depicted arms (107) are about the same size and shape as each other, and have a width substantially less than that of the side of the main body element (103) to which they are attached, and do not have the increased width (113) prior to the gripping element (109). Additionally, in the alternative embodiments of FIG. 2 and FIG. 3 the gripping element (109) may be positioned offset from the center of the main body (103), such that the puncturing spikes create a claw (109) with one side aligning with an edge of the arm (107) and one side extending out in the direction of the longitudinal side of the main body (103).

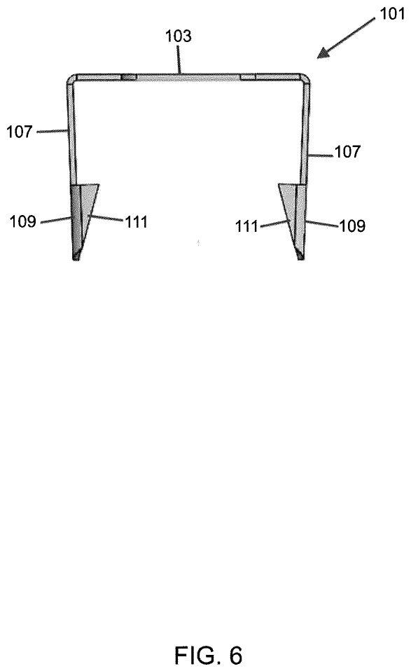

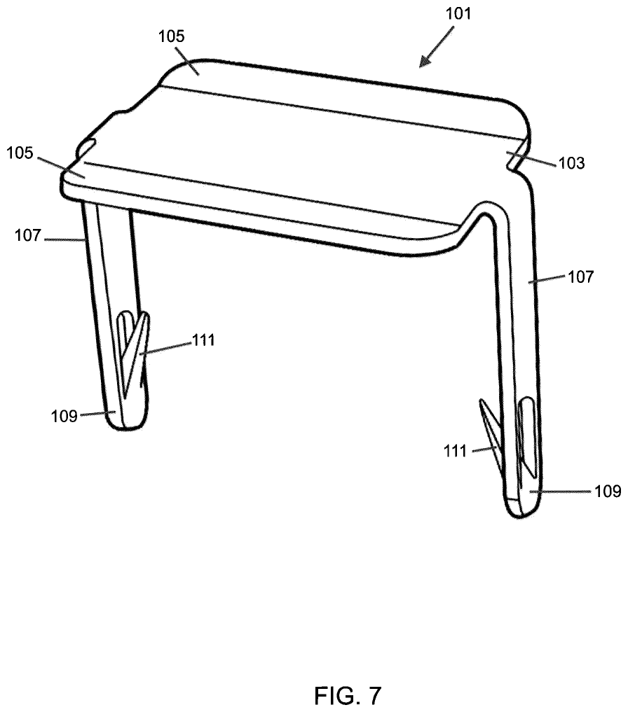

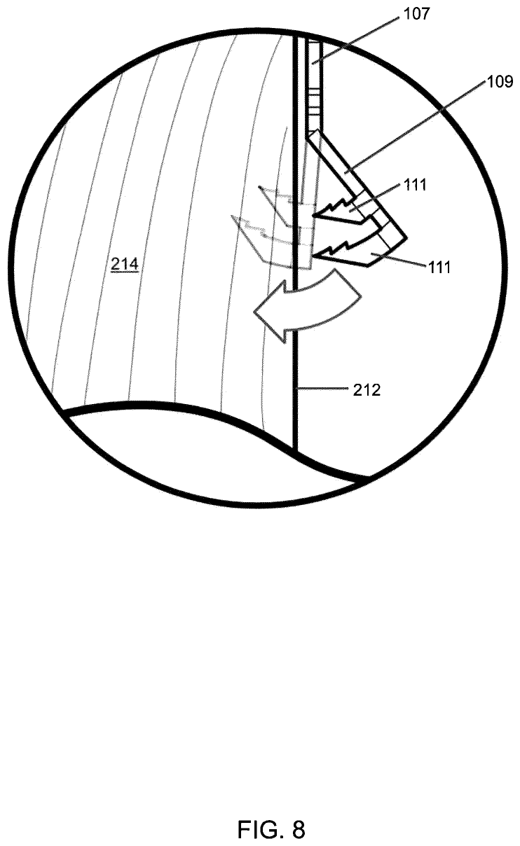

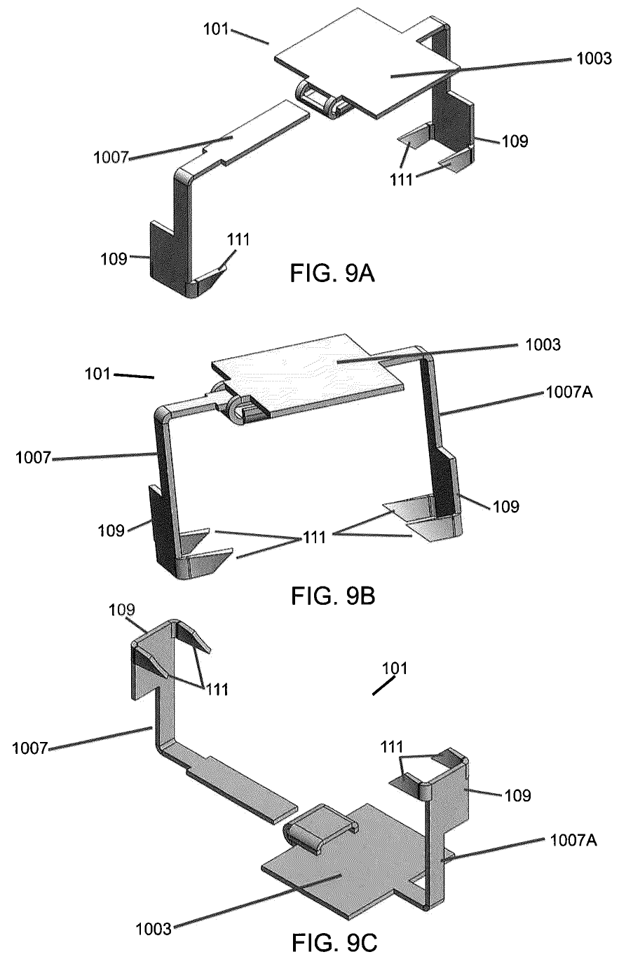

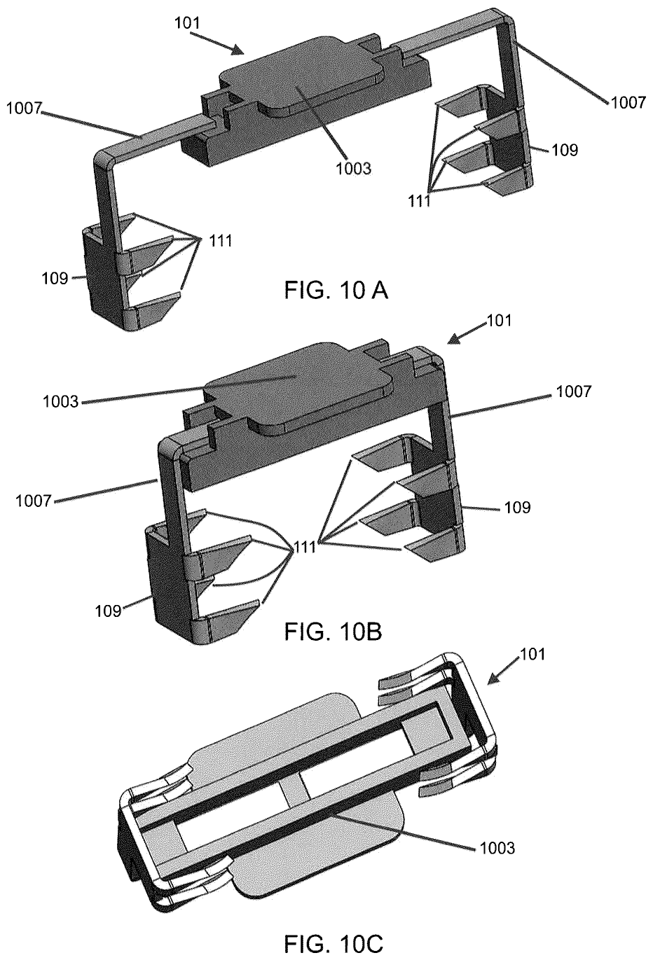

In yet other alternative embodiments, such as depicted in FIG. 9, the main body (1003) and one or more arms (1007) and (1007A) may be a two-piece design, wherein one arm (1007) may be separated from the main body (1003) while one arm (1007A) remains attached to said main body (1003). In a different embodiment, depicted in FIG. 10, the main body (1003) and one or more arms (1007) may be configured in a three-piece design, wherein both arms (1007) may be separated from the main body (1003). In another alternative embodiment, one or more arms (107) may be positioned differently on the main body element (103), such as by having offsetting locations. In another embodiment, arms (107) may be positioned on adjacent sides to one another, such as in an embodiment where the clip is used at a butt joint or other corner configuration of the frame. In a still further embodiment, one or more arms (107) may not extend perpendicularly from the main body element (103), but rather may extend at an acute or obtuse angle, such as in an embodiment where the clip is used to secure boards diagonally rather than perpendicularly to the joists. In yet another embodiment, the arms may not have the same general shape or configuration, but rather one or more arms may have a different length, width, thickness, arrangement of gripping elements (109), or arrangement of puncturing spikes (111), such as depicted in FIGS. 4-8. In further embodiments, one or more of the fastener free deck clips (101) and (101A) may be assembled into a set of collated clips (1501), as shown in FIG. 15.

FIG. 2 and FIG. 3 depict alternate embodiments of a fastener free deck clip where the fastener free deck clip (101) may be manufactured from a flat piece of sheet metal, as seen in the depicted embodiment of FIG. 2, or may also be manufactured using a plastic material or other combinations of other materials. The depicted fastener free deck clip (101) may be bent, in part or in full, into the shape shown in FIG. 3 prior to retail sale, or may be sold in sheet form and bent during the installation process, described elsewhere herein, to a resulting position depicted in FIG. 3.

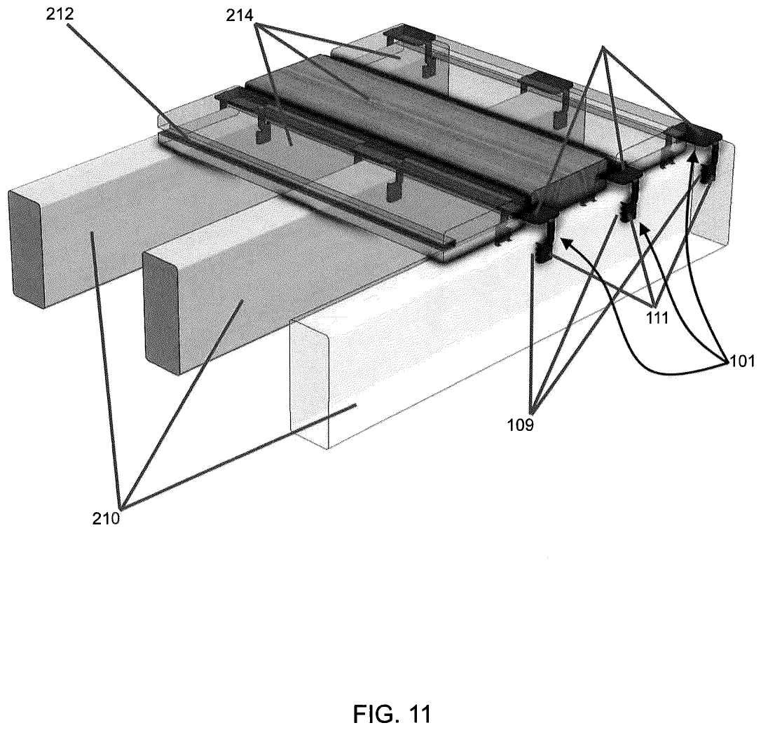

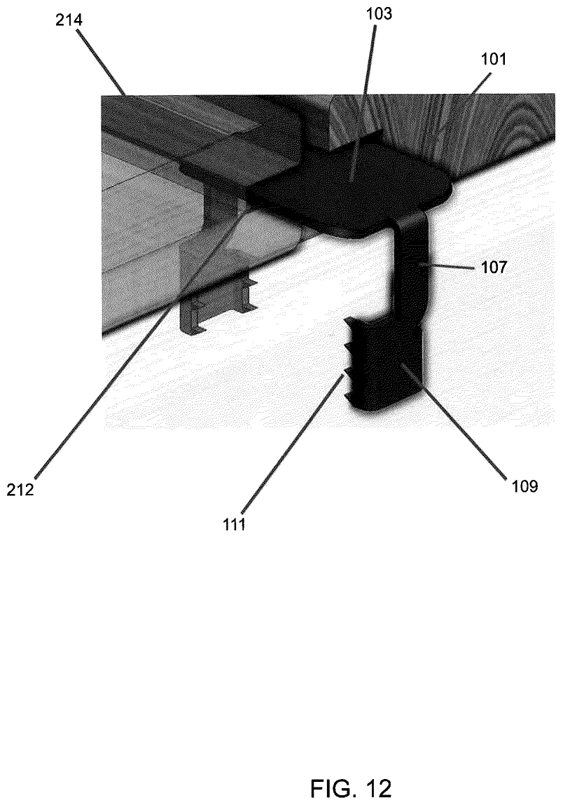

FIG. 10 and FIG. 11 depict deck boards (214) installed atop joists (210) via fastener free deck clips (101). In the depicted embodiment, a fastener free deck clip (101) is installed on a joist, such that the main body (103) is parallel to the top of the joist (210), while the gripping elements (109) penetrate said joist (210). As seen in FIG. 10, a deck board (214) sits perpendicularly atop a joist (210) and is secured in place by inserting a grooved edge (212) of said deck board (214) onto a longitudinal side (105) of a base (103). Each longitudinal side (105) of a fastener free deck clip base (103) is inserted into a grooved edge (212) of a deck board (214), resulting in the fastener free deck clip (101) being hidden from plain view while securing the deck board (214) to the joist (210). This is, however, illustrative only and alternative arrangements are possible. Such as an embodiment described above in paragraph [039] [038] where the fastener free deck clip arms (107) may extend at an acute or obtuse angle and the clip is used to secure deck boards such that they sit diagonally atop joists, rather than perpendicularly.

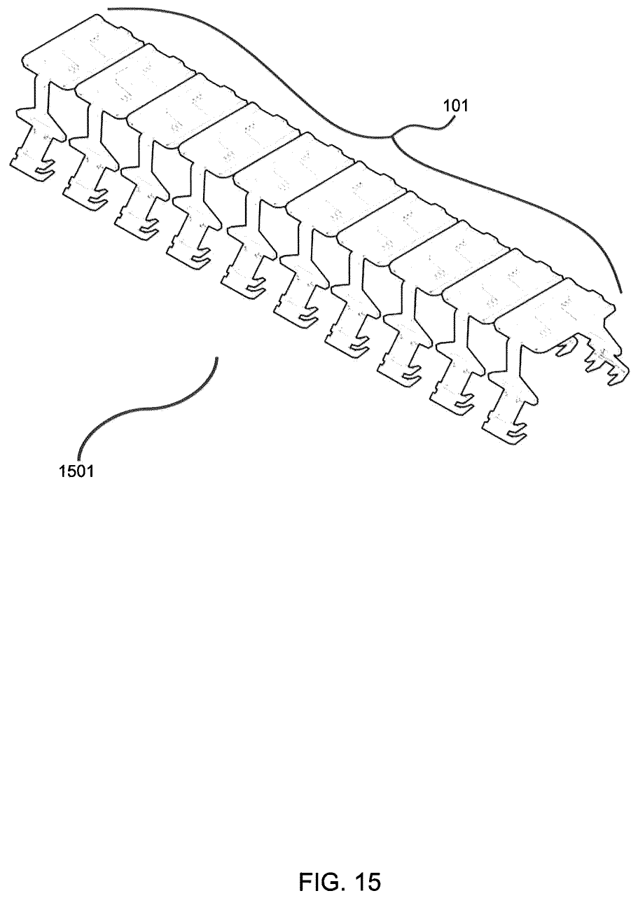

The fastener free deck clip (101) and (101A), or a collated set of such clips (1501) may be installed by a handheld device (1601) as depicted in FIG. 16. This device is a handheld tool that is comprised of a handle (1602) attached to a main body (1604), a strike plate (1606) that may drive the fastener free deck clip in a direction downward from the major plane, a magnet (1608) that may hold the fastener free deck clip in a desired position prior to installation, a lower surface (1610) the fastener free deck clip may rest on as the strike plate is extended downward for installation, and a spring (1612) that may pull the strike plate to a pre-installation position following installation of a fastener free deck clip.

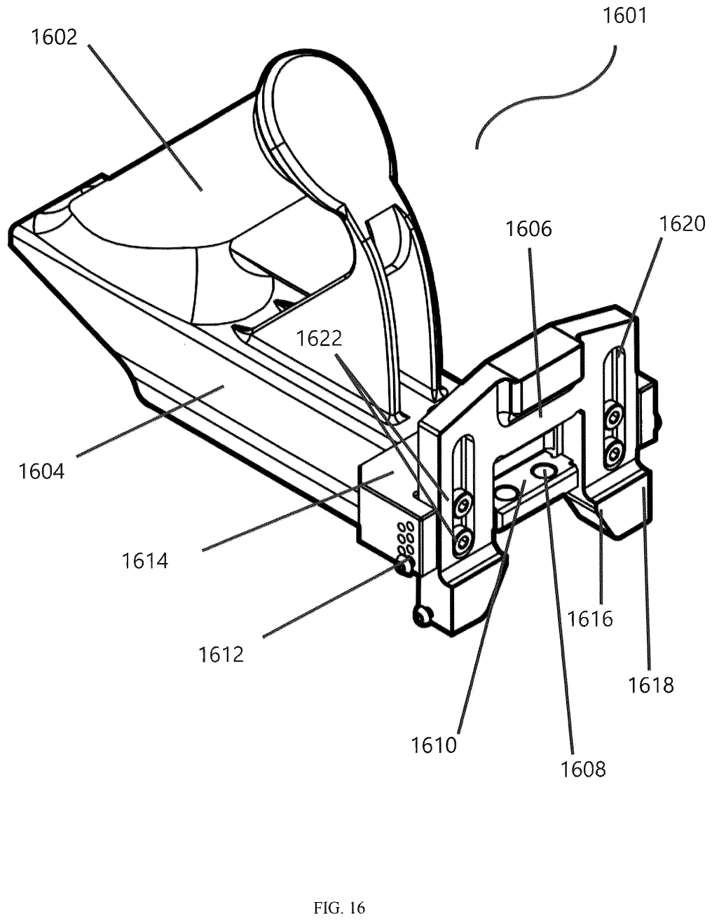

In the depicted embodiments of FIG. 16, FIG. 17, and FIG. 18, the main body (1604) of the handheld device is generally in the configuration of a rectangular prism shape with a planar portion and a lateral portion, but alternative shapes and embodiments are possible. For example, the main body may be configured in a generally square prism shape or may only consist of a planar portion.

In the depicted embodiment, the planar portion of the handheld device main body (1604) is attached to a handle (1602), that may be in the shape of a pistol grip. In an alternative embodiment depicted in FIG. 18, the handle may contain a trigger (1803) to actuate an energy source (1807), such as a pneumatic piston, that initiates a driving force, described elsewhere herein, that drives a strike plate (1805) in a downward direction. However, this is illustrative only and alternative embodiments are possible. For example, an embodiment with the energy source being battery or gas.

A mounting plate (1614) is attached to the main body (1604) on the end opposite the handle (1602) and connects the main body (1604) to a striking plate (1606). The mounting plate (1614) may be wider than the main body (1604), such that the edges of the mounting plate (1614) extend perpendicularly from the main body (1604).

A strike plate (1606) is connected to the mounting plate (1614) opposite the main body (1604). The strike plate is generally in the configuration of a square arch, wherein the lower portion of the interior verticals (1616) of the square arch are angled towards the exterior verticals (1618) of the square arch, as depicted in FIG. 16. The strike plate is attached to the mounting plate (1614) via a bolt (1622) and the verticals of the square arch, which contain an oblong oval slotted channel (1620), are positioned over the bolt (1622), as depicted in FIG. 16. The slotted channel (1620) and bolt (1622) configuration allows the strike plate (1606) movement in an upward and downward direction as guided by the slotted channel (1620) over the bolt (1622).

A lower surface (1610) is connected to the mounting plate (1614) and is positioned in the center of the strike plate, as depicted in FIG. 16. The lower surface (1610) is shaped such that the main body element (103) of the fastener free deck clip may rest on top, with the arms (107) bent downward towards lower interior verticals (1616) of the strike plate square arch. The lower surface may comprise a magnet (1608) located in the center of the lower surface (1610). The magnet (1608) may secure the fastener free deck clip (101) on the lower surface (1610) via magnetic pull.

A spring (1612) is connected from the mounting plate (1614) to the strike plate (1606). The spring (1612) has a resting position of a disengaged strike plate (1606), or put differently, such that the bolts (1622) are located on the bottom of the slotted channel (1620). When force is applied to the strike plate (1606) to drive the strike plate downward, the strike plate is positioned such that the bolts (1622) are located at the top of the slotted channel (1620), and when the force is removed, the spring pulls the strike plate (1606) upward until the spring returns to its aforementioned resting position.

In an alternative embodiment, depicted in FIG. 18, the strike plate may be driven downward by an energy source as opposed to hitting the strike plate with a hammer. In this alternative embodiment, the handle (1602) connected to the tool main body (1604) may contain a trigger (1803), which may send a signal to an energy source (1807) to actuate and drive the strike plate (1805) downwards, as described above. In this embodiment, the speed of install is further increased due to removing a manual action of a user striking the strike plate with a hammer, described elsewhere herein. In this alternative embodiment, the energy source could be any source of energy, such as, but not limited to, pneumatic, battery or gas.

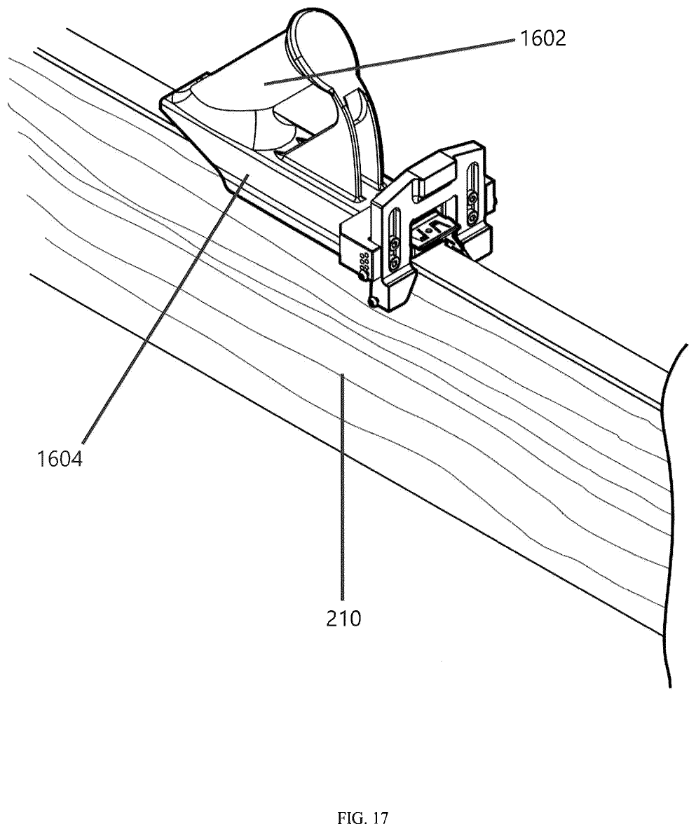

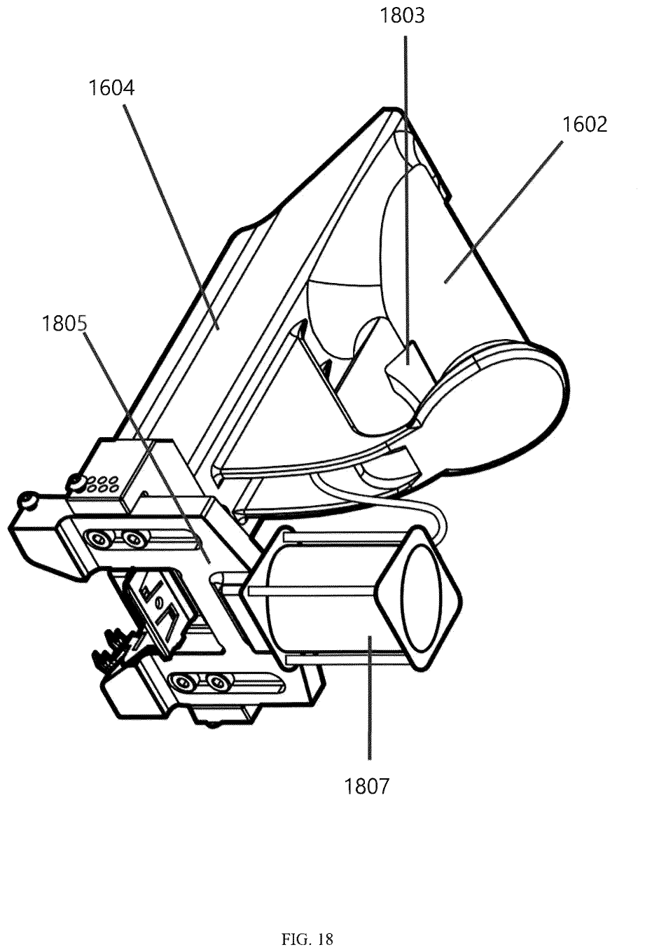

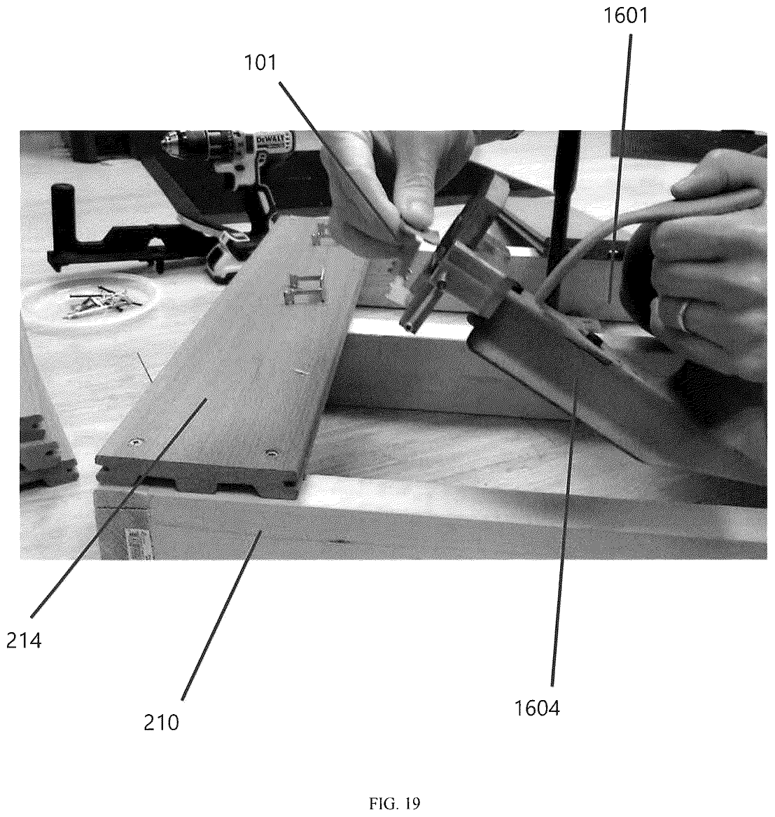

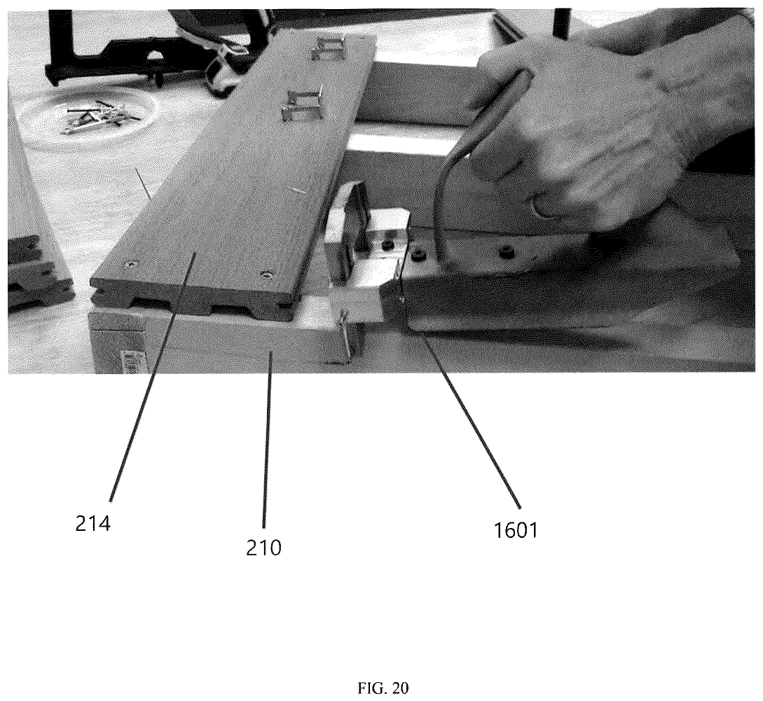

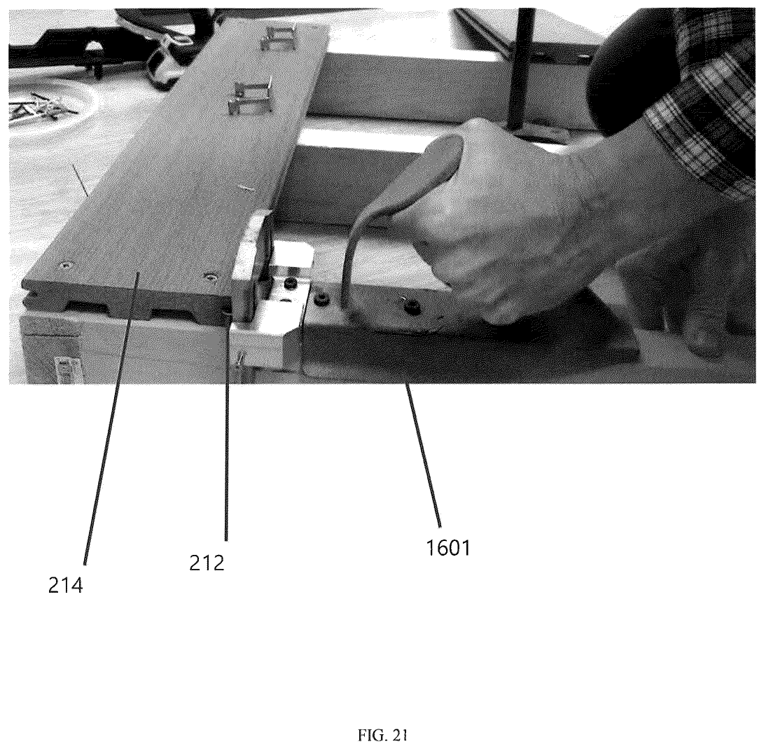

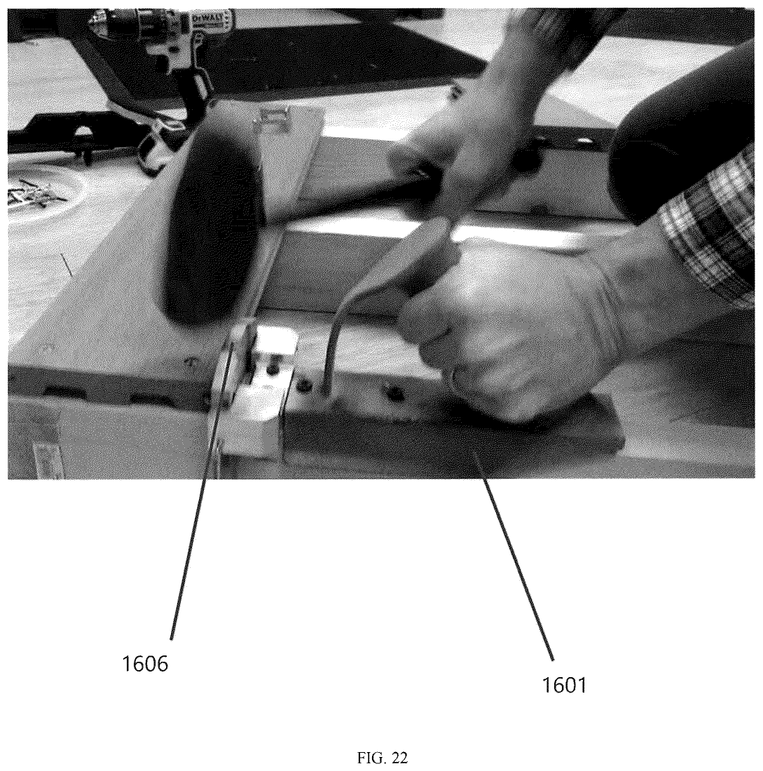

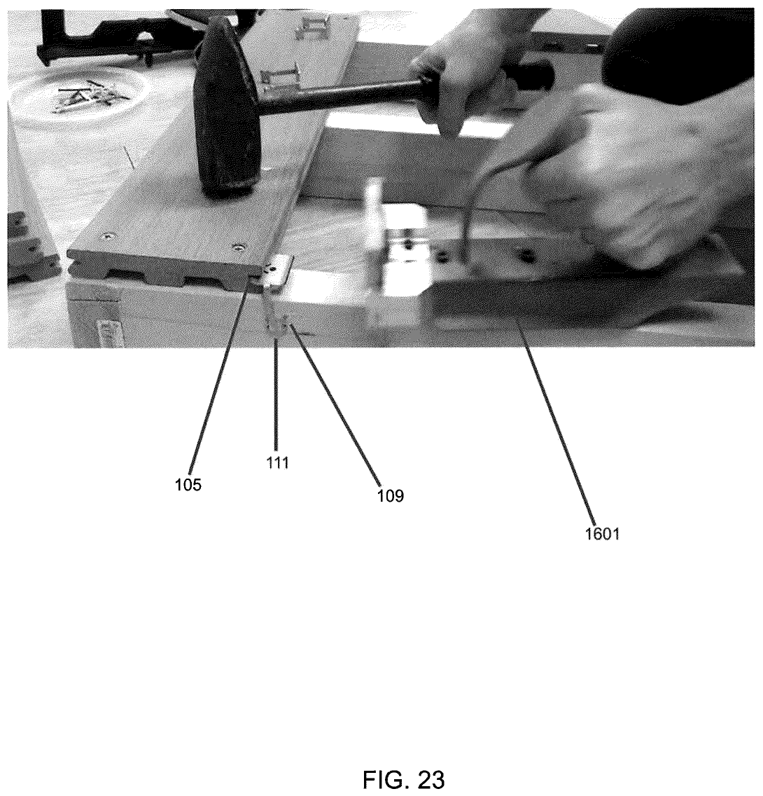

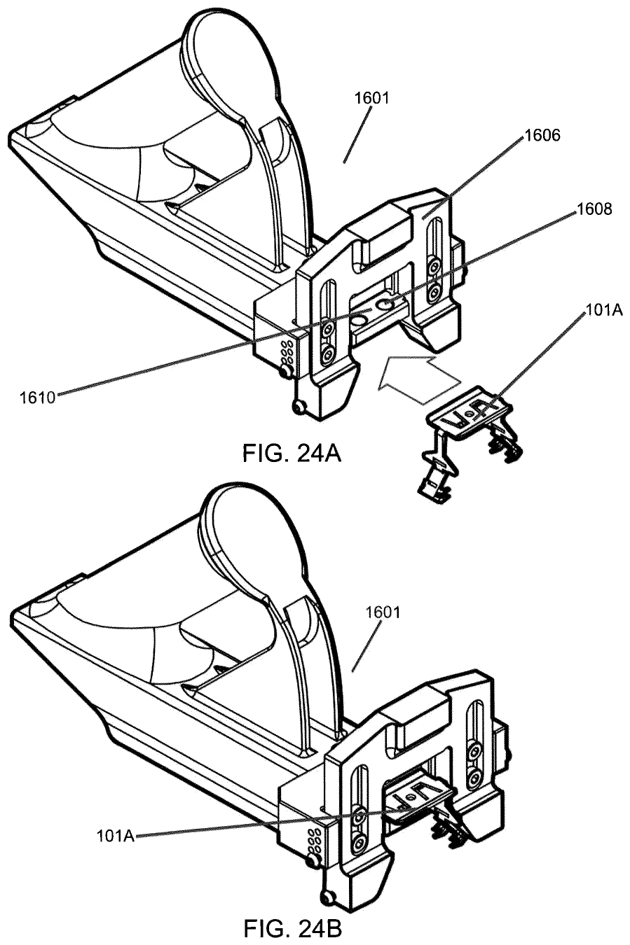

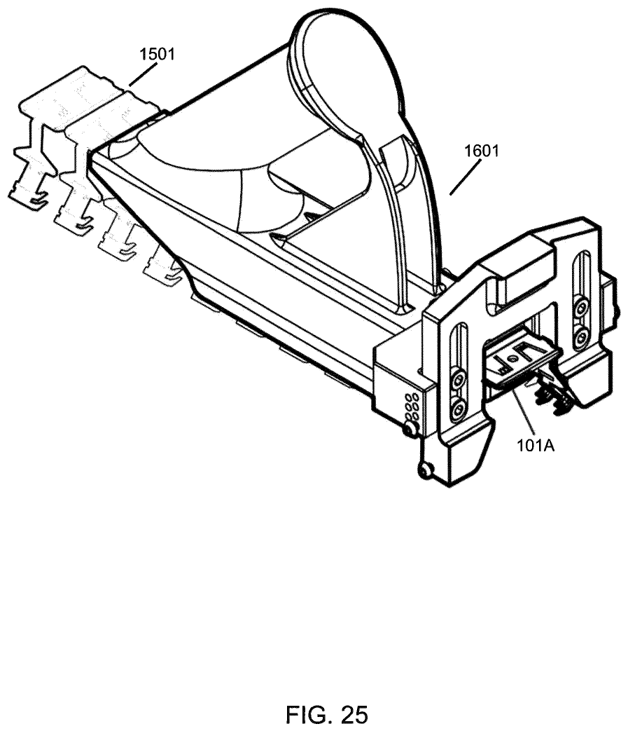

FIGS. 19-24, depict a method for installing and using the fastener free deck clip (101) and (101A). In the depicted embodiment, the deck frame and joists (210) are assembled and one deck board (214) is installed on the joists (210). As will be familiar to a person of ordinary skill in the art, the direction of the deck boards (214) is perpendicular to the joists (210) and the deck boards are installed across multiple joists (210) for stability. A fastener free deck clip (101) or (101A), or a collated set of such deck clips (1501), is placed in the handheld device (1601), as depicted in FIGS. 19, 25, and 26, such that the deck clip base (103) rests on the lower surface (1610) and a magnet (1608) secures the clip in place on the lower surface (1610) prior to installation. While the deck clips may be inserted from the front, rear, bottom, or top of the handheld tool, the clips are inserted from the front in the depicted embodiment of FIG. 25. The hand device (1601) is then placed over a joist, as seen in FIG. 20, and the tool is slid forward to place a fastener free deck clip longitudinal side (105) in the grooved edge (212) of the already installed deck board (214), as seen in FIGS. 20-21. Placing the installation tool over the joist in this manner ensures the fasteners are aligned properly prior to install, reducing the risk of misaligning the fasteners with the underlying joists. While the longitudinal side of the deck clip (105) is inserted in the grooved edge (212) as depicted in FIG. 21, a hammer is used to hit the top center of the strike plate (1606), driving the strike plate downward, which pushes the arms (107) downward and drives the gripping element (109) into the joist (210), securing the deck clip in place, as depicted in FIGS. 22-24. A spring (1612) then pulls the strike plate upwards until the springs returns to its resting position, described previously. The grooved edge (212) of another deck board can then be slid onto the longitudinal side of the installed fastener free deck clip (105) and the subsequent deck board may be snapped into place as seen in FIG. 10. Additional fastener free deck clips and subsequent deck boards may be installed via the above described method.

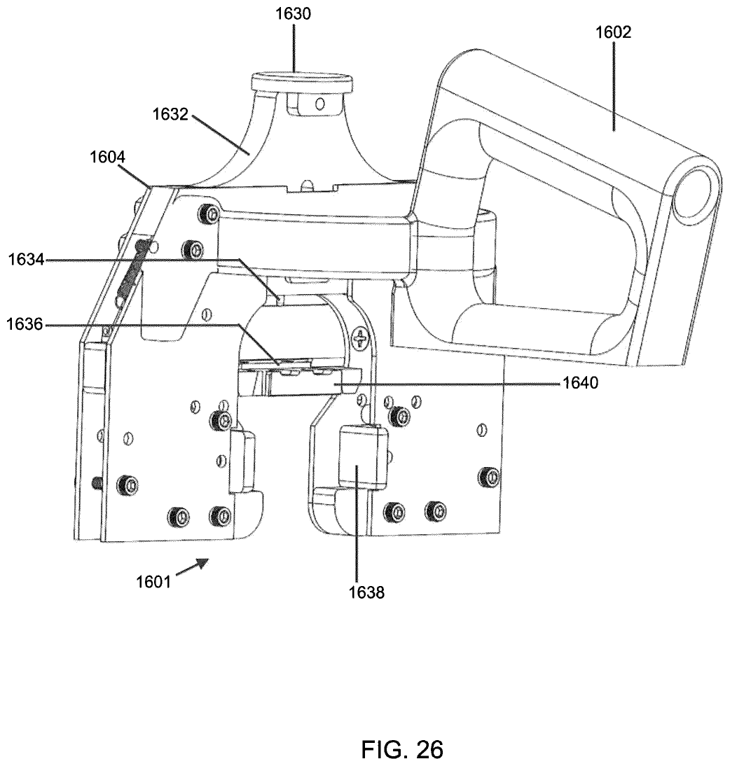

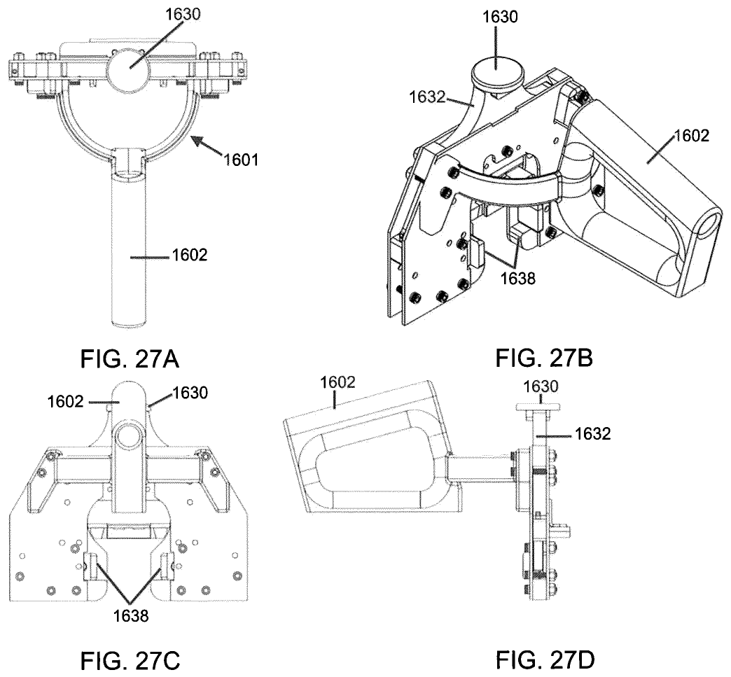

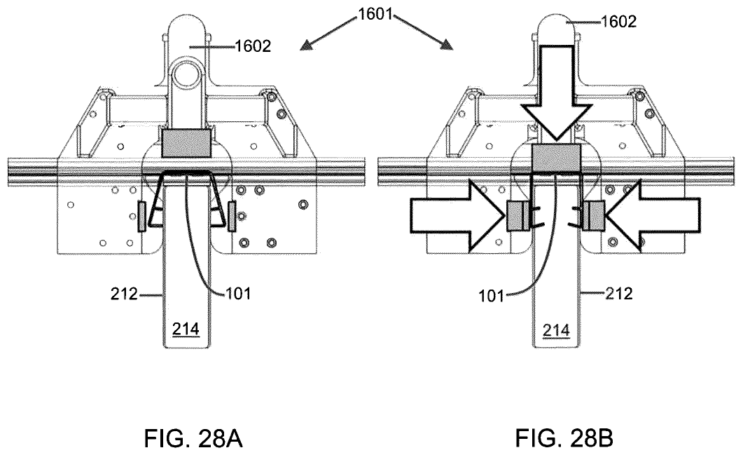

FIGS. 26-28 depict an alternative embodiment of a tool for installing a fastener-free deck clip. The depicted tool (1601) is shown as a hand tool, where the user grips a handle (1602) to position and stabilize the tool (1601) during use. The tool (1601) comprises the handle (1602) connected to a main body (1604), which is shown as a frame sized and shaped to fit over and around a standard size joist and to maintain proper alignment and position during installation. The depicted main body is a vertically aligned, generally flat element, roughly in an inverted U-shape, with two legs extending down from a top section. The two legs straddle the opposing sides of the joist when in use.

The depicted tool (1601) comprises a hammer contact (1630) disposed at a dorsal side and connected to a plunger element (1632) slidingly disposed in the main body (1604) so that it can move up and downward during the use. At the opposing end of the plunger element (1632) is a strike plate (1634). The hammer contact (1630) and strike plate (1634) are generally depicted as planer elements having a flat facing surface.

Disposed below the strike plate (1634) is a retention element (1636) sized and shaped to receive and hold a fastener-free clip (101) in place for installation. This retention element (1636) may be a magnetic element, for example. Also shown disposed below the strike plate is an anvil forming element (1640). The depicted anvil forming element (1640) provides a support surface for the clip (101) when positioned for installation. Its upward-facing surface may be contoured to match the shape of the clip (101) to be used, which may assist in holding the clip in place and inhibiting unwanted movement or dislodging, and in forming the desired shape. In the depicted embodiment, these elements are disposed on a bridge extending horizontally between the legs of the main body (1604), placing a clip (101) disposed in the tool (1601) for installation in position above the joist.

The depicted embodiment also comprises a pair of opposing wing strike plates (1638). In the drawings, these plates (1638) are generally planer, vertically disposed elements (i.e., perpendicular to the anvil forming plate (1640)) disposed along the inside surfaces of the legs of the main body (1604). These plates (1638) provide install performance, particularly due to natural variances in the actual thickness of dimensional lumber.

To use the tool (1601), a clip is placed on the anvil forming plate (1640) and held by the retention element (1636). The depicted tool (1601) applies three vectors of compression: top down, and out-to-in on both sides. The tool (1601) by applying a strike to the hammer contact (1630), which depresses the plunger (1632) into the main body (1604), causing the strike plate (1634) to compress the main body of the clip (101) against the anvil forming plate (1640). At the same time, internal mechanics operate the wing strike plates (1638) to compress them inward, applying compression force to the outside of the clip wings at the gripping elements, and driving them into the side of the joist (210). When the pressure applied by the strike is relieved, the plunger is retracted (e.g., using a spring) to neutral position.

FIGS. 29A and 29B depict one embodiment for achieving this connection. In the depicted embodiment of FIG. 29A, the plunger (1632) is in neutral position, and in FIG. 29B, it is in compressed position. The neutral position of the plunger (1632) is a vertically retracted position in which the plunger (1632) is held at or near the top of its vertical sliding range. In the depicted embodiment, this is achieved through the use of one or more springs (1650), which is connected from the main body (1604) to the plunger (1632) and which extend when the plunger (1632) is lowered. When pressure is released, the springs (1650) withdraw the plunger (1632).

The depicted plunger (1632) is connected to the wing strike plates (1638) by linkages (1642). The depicted linkages (1642) are elongated rectangular elements pivotably attached to the plunger (1632) near its bottom end, and also pivotably attached to one of the wing strike plates (1638) on a lateral side. The wing strike plates (1638) are configured for lateral movement—i.e., towards the vertical midline of the tool from outside-to-inside, and vice versa. Thus, when the plunger (1632) is lowered, the pivotal connection of the linkages to both plunger (1632) and wing strike plate (1638), combined with the angle of connection, translates the downward movement of the plunger (1632) into an inward force vector on the linkages (1642), which then translate that movement to the wing strike plates (1638). Conversely, when the plunger is raised, these forces reverse and the linkages (1642) pull the wing strike plates (1642) outward to neutral position. This movement may be further assisted by springs (1650). Generally, the placement, size, shape, configuration, angles, and other characteristics of these elements are selected to convert a portion, but not all, of the vertical motion of the plunger (1632) into horizontal motion of the wing strike plates (1638). The precise configuration will depend on the amount of force that is desired to be converted, which will in turn be a function of the amount of force desired to be applied to the various parts of the clip. This in turn may depend on the size, shape, and configuration of the particular clip with which the tool is used. It will be understood that while linkages (1642) are shown, other shapes and configurations are possible, including implementations that do not require linkages. For example, corresponding angled surfaces could be used (e.g., a 45 degree angled bottom surface of the plunger (1632) which slides against a corresponding angled top surface of the wing plates (1638) or another component operatively coupled to it. Other mechanisms for achieving conversion of the direction of force are also possible and some are known in the art.

Throughout this disclosure, geometric terms may be used to characterize, among other things, sizes, shapes, dimensions, angles, distances, and relationships. These terms may be used with qualifiers such as “generally,” “about,” and “approximately.” One of ordinary skill in the art will understand that, in the context of this disclosure, these terms are used to describe a recognizable attempt to conform a device or component to the qualified term. By way of example and not limitation, components described as being “generally coplanar” will be recognized by one of ordinary skill in the art to not be actually coplanar in a strict geometric sense because a “plane” is a purely geometric construct that does not actually exist and no component is truly “planer,” nor are two components ever truly coplanar. Variations from geometric descriptions are unavoidable due to, among other things, manufacturing tolerances resulting in shape variations, defects, imperfections, non-uniform thermal expansion, natural wear, minor variations that are nevertheless recognizable as the qualified term, and other deformations. One of ordinary skill in the art will understand how to apply geometric terms, whether or not qualified by relative terms such as “generally,” “about,” and “approximately,” to describe a reasonable range of variations from the literal geometric term in view of these and other considerations appropriate to the context.

Additionally, the use of the conjunctive and disjunctive should not necessarily be construed as limiting, and the conjunctive may include the disjunctive, and vice versa. Likewise, the recitation of components, or quantities of components, should not be understood as limiting unless otherwise specified; that is, reciting “an element” should be understood to mean “an element” is present, but should not be understood to implicitly exclude the presence of additional unrecited elements.

In this application, relative directional terms such as “up,” “down,” “inward,” “outward,” “descend,” and “ascend” and the like, are used to describe the positioning and movement of elements with respect to their orientation as depicted in the accompanying figures, and it should be understood that these terms are intended to provide a frame of reference based on the orientation of the object as shown in the drawings. For example, “outward” refers to movement away from the center of the object, and “inward” refers to movement toward the center. Similarly, directional terms such as “up” and “down” describe directions relative to the orientation in the figures and do not necessarily correspond to directions relative to gravity in real world embodiments, depending on how the elements are oriented in the real world. These directional terms are meant to facilitate an understanding of the invention as shown and should not be limited to any particular real-world orientation.

It will be understood that when components may be operated by tension elements, such as springs, these tensile elements and components in contact with them have a positions in which the tensile elements are not materially tensioned. Sometimes called a “rest state” or “equilibrium state” in physics, this is a state of the physical systems in which major forces (e.g., spring tension) are balanced or inactive, and the resulting position of the device and/or individual components may be referred to as a “natural” or “neutral” position. Of note, one or more components may be in a neutral state at the same time that others are not.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A deck clip comprising:
a main body element comprising:
a central portion generally in the configuration of a rectangular prism having a major plane; and
a first longitudinal portion adjacent a first side of said central portion and comprising an extension of said central portion above said major plane; and
a second longitudinal portion adjacent a second side of said central portion and comprising an extension of said central portion above said major plane;
a pair of arms disposed on opposing sides of said main body element and extending generally colinearly therefrom in opposing directions, a major axis of each of said arms generally perpendicular to said major plane; and
a gripping element disposed at a distal end of each of said arms, said gripping elements each comprising one or more puncturing spikes.

2. The deck clip of claim 1, further comprising a first flexible tab cut out of said main body element such that said first tab is not connected to said main body element on three sides, said first tab bending downwards from said major plane in a direction opposite said first longitudinal portion and said second longitudinal portion.

3. The deck clip of claim 2, further comprising a second flexible tab cut out of said main body element such that said second tab is not connected to said main body element on three sides, said second tab bending downwards from said major plane in a direction opposite said first longitudinal portion and said second longitudinal portion.

4. The deck clip of claim 3, wherein each of said arms is about the same size as the other and has a width that increases at said distal end prior to the gripping element.

5. The deck clip of claim 4, wherein at least one of said arms is mechanically separable from said main body element.

6. The deck clip of claim 5, wherein both of said arms are mechanically separable from said main body element.

7. The deck clip of claim 6, wherein said puncturing spikes are generally in a triangular configuration and extending generally perpendicularly from said gripping elements.

8. The deck clip of claim 7, wherein said deck clip is manufactured from a flat piece of sheet metal and bent into shape.

9. The deck clip of claim 8, wherein said first body element further comprises a bore extending through said main body element from a top side to a bottom side.

10. The deck clip of claim 9, wherein said bore is disposed in about a center of said main body element.

11. A collated set of deck clips comprising a plurality of said deck clip of claim 1 arranged linearly.

12. A method of installing a deck clip, comprising:
providing a deck clip comprising:
a main body element comprising:
a central portion generally in the configuration of a rectangular prism having a major plane; and
a first longitudinal portion adjacent a first side of said central portion and comprising an extension of said central portion above said major plane; and
a second longitudinal portion adjacent a second side of said central portion and comprising an extension of said central portion above said major plane;
a pair of arms disposed on opposing sides of said main body element and extending generally colinearly therefrom in opposing directions, a major axis of each of said arms generally perpendicular to said major plane; and
a gripping element disposed at a distal end of each of said arms, said gripping elements each comprising one or more puncturing spikes;
disposing said deck clip atop a decking joist such that said main body element is parallel to a top side of said decking joist and each of said arms is disposed parallel to a lateral side of said decking joist; and
driving said gripping elements of each of said arms toward a midpoint of said decking joist until said puncturing spikes are embedded in said decking joist.

13. The method of claim 12, further comprising:
said deck clip further comprising:
a first flexible tab cut out of said main body element such that said first tab is not connected to said main body element on three sides, said first tab bending downwards from said major plane in a direction opposite said first longitudinal portion and said second longitudinal portion; and
a second flexible tab cut out of said main body element such that said second tab is not connected to said main body element on three sides, said second tab bending downwards from said major plane in a direction opposite said first longitudinal portion and said second longitudinal portion;
driving said first flexible tab and said second flexible tab into said top of said decking joist.

14. The method of claim 13, further comprising:
providing a tool for installing said deck clips, said tool comprising a handle attached to a main body having a hammer contact operatively connected to a strike plate;
said disposing said deck clip atop said decking joist further comprising disposing said tool on said decking joist such that said such that said strike plate is disposed above said top of said decking joist, and disposing said deck clip in a said tool;
striking said hammer contact; and
said striking operating said strike plate to compress said main body element against said top of said decking joist.

15. The method of claim 14, further comprising:
said tool further comprising said main body being generally in the configuration of an inverted U-shape comprising a pair of legs extending downward from opposing sides of a top section, each of said legs having a wing strike plate disposed on an inner surface thereof, said wing strike operatively coupled to said hammer contact;
said disposing said deck clip atop said decking joist further comprising disposing said tool on said decking joist such that said such that said legs of said tool straddle said decking joist and each of said arms are disposed between said decking joist and one of said legs of said tool; and
said striking further operating each of said wing strike plates to compress one of said arms of said deck clip against a lateral surface of said decking joist.
